(19) United States
(12) Patent Application Publication
(10) Pub. No.: US 2011/0225775 A1
(43) Pub. Date: Sep. 22, 2011

(54) Bag Closure Device

(75) Inventor: Hisao Miwa, Toyama City (JP)

(73) Assignee: RICHELL CORPORATION, Toyama City (JP)

(21) Appl. No.: 12/727,934

(22) Filed: Mar. 19, 2010

(51) Int. Cl. B65D 33/16; B23P 11/00

(52) U.S. Cl. 24/30.5 R; 29/428

(57) ABSTRACT

In an embodiment of the disclosure, a bag closure device is disclosed. The bag closure device comprises a receiving member that comprises a securing fin. The bag closure device also comprises a guide member. One end of the receiving member is coupled to one end of the guide member.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE DISCLOSURE

This disclosure relates to a bag closure device for closing a bag.

### BACKGROUND OF THE DISCLOSURE

Food products are often packaged in bags. If a bag is not properly closed once it has been opened, the food in the bag may be exposed to air and become stale. Such a result is undesirable because it often results in having to throw away the food earlier than necessary (i.e., prior to the expiration date).

### SUMMARY OF THE DISCLOSURE

In an embodiment of the disclosure, a bag closure device is disclosed. The bag closure device comprises a receiving member that comprises a securing fin. The bag closure device also comprises a guide member. One end of the receiving member is coupled to one end of the guide member.

In another embodiment of the disclosure, a bag closure device is disclosed. The bag closure device comprises a receiving member that comprises a distal end, a proximal end, and securing fin. The receiving member has a T-shaped cross-sectional shape. The bag closure device also comprises a guide member that comprises an entry end, a back end, and a slot. The entry end is gradually elevated and defines a space. Additionally, the proximal end of the receiving member is coupled to the back end of the guide member. Furthermore, the slot of the guide member receives the securing fin of the receiving member.

In yet another embodiment of the disclosure, a method for manufacturing a bag closure device is disclosed. The method comprises forming a receiving member comprising a distal end, a proximal end, and a securing fin. The method also comprises forming a guide member comprising an entry end, a back end, and a slot. The method further comprises inserting the receiving member through the entry end of the guide member and coupling the proximal end of the receiving member to the back end of the guide member after the inserting of the receiving member through the entry end.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a top view of a bag closure device according to an embodiment of the present invention.

FIG. 2 is a side view of a bag closure device according to an embodiment of the present invention.

FIG. 3 is a bottom view of a bag closure device according to an embodiment of the present invention.

FIG. 4 is a front view of a bag closure device according to an embodiment of the present invention.

FIG. 5 is a perspective view of a bag closure device according to an embodiment of the present invention.

FIG. 6 is a top view of a bag closure device according to an embodiment of the present invention.

FIG. 7 is a top view of a bag closure device according to an embodiment of the present invention.

FIG. 8 is a side view of a bag closure device according to an embodiment of the present invention.

FIG. 9 is a perspective view of a bag closure device according to an embodiment of the present invention.

FIG. 10 is an explanatory drawing that illustrates how to use a bag closure device according to an embodiment of the present invention.

FIG. 11 is an explanatory drawing that illustrates an end result of using a bag closure device according to an embodiment of the present invention.

FIG. 12 is an explanatory drawing that illustrates an end result of using a bag closure device according to an embodiment of the present invention.

FIG. 13 is a flow chart illustrating a method of manufacturing a bag closure device.

### DETAILED DESCRIPTION OF THE PREFERRED EMBODIMENTS

The disclosure provides a bag closure device that may be used to close a bag. In one embodiment, the bag closure device comprises a receiving member and a guide member. The bag closure device enables an opened bag, especially a hard to close bag such as a dog food bag, to be closed in a secure fashion. In an embodiment, when a load is applied, the bag is secured between the receiving member and the guide member. Additionally, the bag may be secured between a securing fin of the receiving member and a slot of the guide member. In some embodiments and in some orientations the bag may be secured between the wide portion of the main body of the receiving member and the area of the guide member around the slot, on one or both sides of the slot, and between the securing fin of the receiving member and the inside or corners of the slot. This secure closing of the bag created by the bag closure device reduces, and may even eliminate, the flow of air into and out of the bag, which helps to extend the shelf life of the food in the bag prior to going stale or spoiling as well as reducing the emission of odors from the bag into the surrounding area.

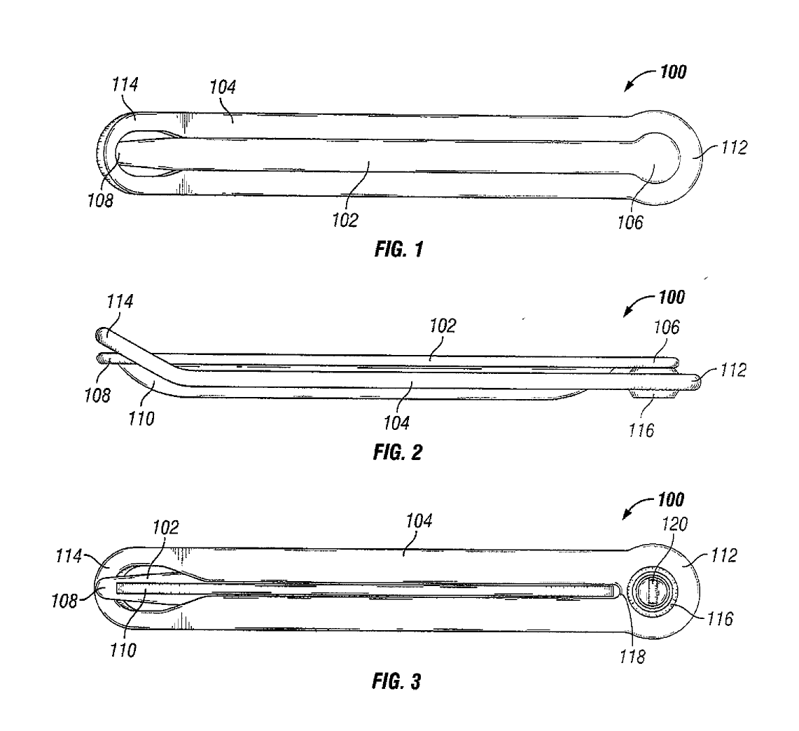

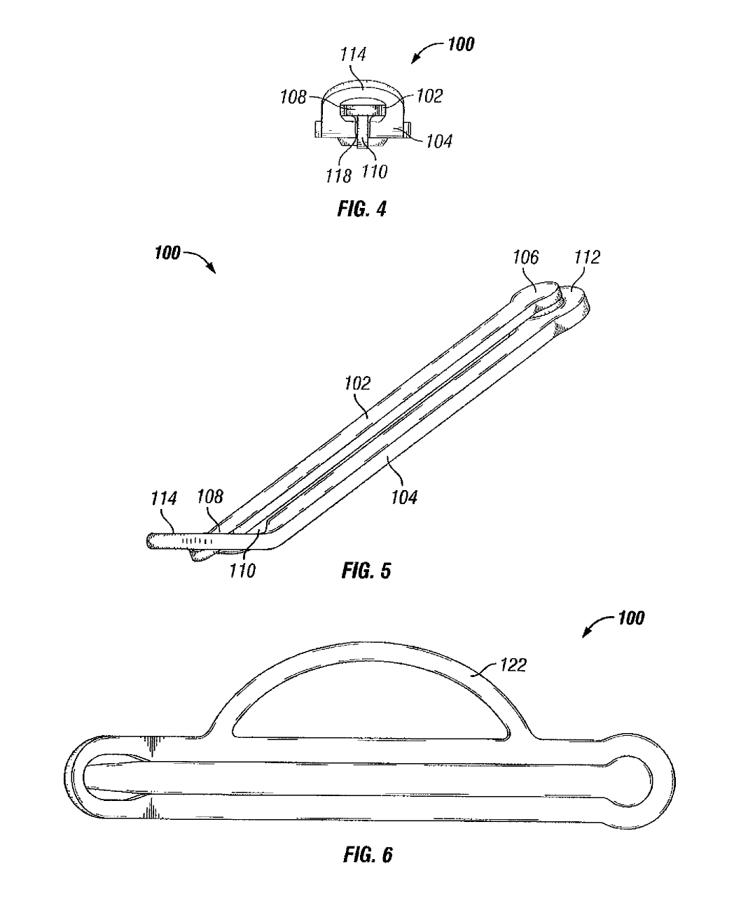

FIGS. 1-5 illustrate an embodiment of the bag closure device 100. The bag closure device 100 may comprise a receiving member 102 and a guide member 104. As will be discussed in greater detail below, the receiving member 102 may receive a folded bag and the guide member 104 may help to guide the folded bag onto the receiving member 102. Also, as will be discussed in greater detail below, one end of the receiving member 102 is coupled to one end of the guide member 104. Coupled as used herein means directly or indirectly coupled.

In a preferred embodiment, the receiving member 102 and the guide member 104 are made of plastic. However, the receiving member 102 and/or the guide member 104 may be made of another material.

Additionally, the size of bag closure device 100, and specifically the size of the receiving member 102 and the guide member 104, may vary. For example, there may be a very small sized bag closure device 100 designed to hold a very small sized bag, a small sized bag closure device 100 designed to hold a small sized bag, a medium sized bag closure device 100 designed to hold a medium sized bag, a large sized bag closure device 100 designed to hold a large sized bag. In an embodiment, the length of the bag closure device 100, and more particularly the length the receiving member 102 and the guide member 104, is longer than the length of the opened end of the bag to be received.

Referring again to FIGS. 1-5, the receiving member 102 may comprise a proximal end 106, a distal end 108, a securing fin 110, and a male connector 120. The connector could alternatively be female or one half of a mating connector arrangement. In a preferred embodiment, excluding the proximal end 106, the distal end 108, and the securing fin 110, the receiving member 102 has a rectangular cross-sectional shape. The receiving member 102, excluding the proximal end 106, the distal end 108, and the securing fin 110, also may have a triangular, hexagonal, pentagonal, octagonal, cylindrical, T-shaped, cross-shaped, or any other shaped cross-sectional shape.

In an embodiment, the length of the receiving member 102 is less than the length of the guide member 104. The width of the receiving member 102 also may be less than the width of the guide member 104. For example, the width of the receiving member 102, excluding the proximal end 106 and the distal end 108, may be approximately a third of the width of the guide member 104. In other embodiments, the width of the receiving member 102 may be smaller or larger than a third of the width of the guide member 104. In an embodiment, the width of the main body of receiving member 102 is larger than the width of a slot 118 of the guide member 104. This width of the receiving member 102 enables that a bag will be constrained by the interaction between the main body of the receiving member 102 and the area around the slot 118 when the bag is fitted between receiving member 102 and the guide member 104 and through the slot 118.

The distal end 108 of the receiving member 102 is located furthest away from the point where the receiving member 102 is coupled to the guiding member 104. The distal end 108 of the receiving member 102 receives a bag. In a preferred embodiment, the distal end 108 is rounded. For example, referring to FIGS. 1 and 3, the receiving member 102 may gradually narrow into a rounded point at the distal end 108. Such a graduated narrowing at the distal end 108 enables the receiving member 102 to receive a bag with greater ease.

Because the distal end 108 is furthest away from the point where the receiving member 102 is coupled to the guide member 104, the distal end 108 of the receiving member 102 is capable of movement as is illustrated in FIGS. 2, 4, and 5. In an embodiment, the movement of the distal end 108 of the receiving member 102 is restricted by an entry end 114 of guide member 104. The movement of the distal end 108 of the receiving member 102 also enables the receiving member 102 to receive a bag with greater ease. For example, when placing a bag on the distal end 108 of the receiving member 102, the distal end 108 can be moved upward thereby creating more space for the bag. As the bag is slid laterally along the receiving member 102, the weight of the bag forces the receiving member 102 down against the guide member 104 thereby securely fitting the bag between the receiving member 102 and the guide member 104.

The proximal end 106 of the receiving member 102 is located closest to the point where the receiving member 102 is coupled to the guiding member 104. The proximal end 106 of the receiving member 102 may be round, square, triangular, rectangular, pentagonal, heptagonal, hexagonal, octagonal, or any other shape. In an embodiment, the proximal end 106 of the receiving member 102 mirrors the shape of a back end 112 of the guide member 104. For example, as is illustrated in FIGS. 1 and 5, both the proximal end 106 of the receiving member 102 and the back end 112 of the guide member 104 may be similarly shaped with the proximal end 106 being smaller than the back end 112.

The male connector 120 may be coupled to the proximal end 106 of the receiving member 102. The male connector 120 may protrude from the proximal end 106 of the receiving member 102 and may be substantially perpendicular to the receiving member 102. The male connector 120 may be located substantially in the center of the proximal end 106. In an alternate embodiment, the male connector 120 is a female connector or one half of a mating connector arrangement.

As mentioned above, one end of receiving member 102 is coupled to one end of the guide member 104. In an embodiment, the male connector 120 is the means by which the proximal end 106 of the receiving member 102 is coupled to one end of the guide member 104. For example, the male connector 120 may be received by a female connector 116 of the guide member 104. In an embodiment, the male connector 120 is of size and shape such that the male connector 120 can be conveyed through the female connector 116. The male connector 120 also may comprise a tip that is slightly larger than the body of the male connector 120 so as to help prevent the removal of the male connector 120 from the female connector 116. In an alternative embodiment, the female connector 116 could alternatively be male or one half of a mating connector arrangement.

The securing fin 110 of the receiving member 102 may protrude from the bottom of the receiving member 102. In an embodiment, the securing fin 110 is substantially perpendicular to the receiving member 102. The securing fin 110 may be largely in the middle of the width of the receiving member 102.

The securing fin 110 may have a rectangular cross-sectional shape. In an embodiment, one end of the securing fin 110 is curved. In another embodiment, both ends of the securing fin 110 are curved. For example, referring to FIGS. 2 and 3, the ends of the securing fin 110 may curve until they meet the receiving member 102. The securing fin 110 may also have a triangular, T-shaped, or any other shaped cross-sectional shape.

The length of the securing fin 110 may be less than the length of the receiving member 102. The width of the securing fin 110 is at least in part less than the width of the slot 118 of the guide member 104 which receives the securing fin 110. In an embodiment, the width of the securing fin 110 is a size such that a folded bag and the securing fin 110 are capable of being received by the slot 118 of the guide member 104 in a secure fashion. Such a width of the securing fin 110 enables a bag to be securely closed and helps to prevent the inflow and outflow of air to the bag.

The height of the securing fin 110 may be greater than the height of the slot 118. For example, as illustrated in FIG. 2 the height of the securing fin 110 may be such that the securing fin 110 protrudes beyond the slot 118. Such a height of the securing fin 110 ensures that at least a part of the securing fin 110 remains within the slot 118.

The securing fin 110 helps to provide structural support for the receiving member 102. For example, the securing fin 110 may help to reduce, and in some cases prevent, flex in the receiving member 102. Additionally, the securing fin 110 also may secure the bag such that the bag cannot be pulled off the receiving member 102. For example, if the bag on the receiving member 102 is pulled, the securing fin 110 may act as a stopping force component with one or both sides of the slot 118 to prevent the bag from being pulled off the receiving member 102 through the slot 118. Furthermore, as discussed above, the securing fin 110 and the slot 118 may enable a bag to be securely fitted within the slot 118, which may reduce, and in some cases eliminate, the flow of air into and out of the bag and thereby help to prevent the food in the bag from going stale.

In an embodiment, the receiving member 102 including the securing fin 110 has a T-shaped cross-section shape. As discussed above, the width of the receiving member 102 is greater than the width of the slot 118. Also, as discussed above, the height of the securing fin 110 may be greater than the height of the slot 118. Thus, in one embodiment, the receiving member 102 has a T-shaped cross-sectional shape with each end of the T extending passed the boundaries of the slot 118. Such a cross-sectional shape of the receiving member 102 enables a secure fitting of a bag within the bag closure device 100. For example, because the receiving member 102 extends beyond the slot 118, a bag can be securely fitted between the main body of the receiving member 102 and the main body of the guide member 104 (i.e., the area of the guide member 104 around the slot 118). Additionally, because the securing fin 110 of the receiving member 102 extends beyond the slot 118, the securing fin 110 helps to keep the bag on the receiving member 102. Further, the size of the securing fin 110 and the slot 118 ensure that the bag is firmly fitted within the slot 118. Such a fitting of a bag created by the bag closure device 100 reduces the influx of outside air into the bag once the bag is on the bag closure device 100. In some cases, the bag closure device 100 may create substantially a seal against fluids such as air or water or both gases and liquids. In any embodiment, the bag closure device 100 helps to prevent the food in the bag from going stale.

In an alternate embodiment, the receiving member 102 including the securing fin 110 may have an I-shaped cross-sectional shape. For example, the securing fin 110 may have an inverted T-shaped cross-sectional area. Such a cross-sectional shape may provide even greater protection in regard to preventing the bag from being pulled off the receiving member 102. Also, an I-shaped cross-sectional shape may enable a bag to be even more securely fitted within the bag closure device 100, which may further reduce the amount of air that enters and exits the bag while the bag is on the bag closure device 100. Such a shape might also improve performance if the bag and closure device are dropped or moved past 90 degrees from the horizontal such that the force of the bag on the closure device has a component pulling away from the guide member 104 towards the main body of the receiving member 102. In such an instance the same component would be pulling the T portion of the securing fin 110 towards the guide member 104 with the bag in between. Embodiments illustrating this benefit could occur with a fin profile of a T, an inverted triangle, or other profiles where at least some of the portion of the securing fin 110 away from the receiving member 102 increases in width from the initial portion extending from the receiving member 102. In some embodiments at least some of this wider portion of the securing fin 110 would be wider than the majority of the slot 118.

The guide member 104 may comprise the back end 112, the entry end 114, the female connector 116, and the slot 118. In a preferred embodiment, excluding the back end 112, the entry end 114, and the slot 118, the guide member 104 has a rectangular cross-sectional shape. The guide member 104, excluding the back end 112, the entry end 114, and the slot 118, may also have a triangular, hexagonal, pentagonal, octagonal, cylindrical, or any other shaped cross-sectional shape. In an embodiment, the length of the guide member 104 is greater than the length of the receiving member 102. The width of the guide member 104 may also be greater than the width of the receiving member 102.

The back end 112 of the guide member 104 is located nearest the point where the receiving member 102 is coupled to the guide member 104. In a preferred embodiment, the back end 112 of the guide member 104 is round. A rounded back end 112 of the guide member 104 enables easy removal of the bag closure device 100 from a bag by acting as a stopping force component. For example, a rounded back end 112 prevents a user's hand from slipping while the user pulls and thereby removes the bag closure device 100 from the bag. In an alternate embodiment, the back end 112 is squared, triangular, rectangular, pentagonal, heptagonal, hexagonal, octagonal, or any other shape.

The female connector 116 may be located on the back end 112 of the guide member 104. In an embodiment, the female connector 116 of the guide member 104 receives the male connector 120 of the receiving member 102. In such an embodiment, the female connector 116 is of such a size and shape that the male connector 120 can be conveyed through the female connector 116, but the male connector 120 is prevented from being pulled back through the female connector 116. The male connector 120 may be securely situated in the female connector 116 such that the male connector 120 prevents the detachment of the male connector 120 from the female connector 116 of the guide member 104. In an alternate embodiment, the female connector 116 is a male connector or one half of a mating connector arrangement of male and female mating connectors or gender neutral mating connectors. In such embodiments the proximal end 106 of the receiving member 102 is coupled to the back end 112 of the guide member 104 when a first half of the mating connector 120 and a second half of the mating connector 116 connect to one another.

The slot 118 may be located substantially through the center of the guide member 104. In an embodiment, the slot 118 is substantially rectangular although other more rounded configurations or alternative partially non-linear configurations with teeth or bumps on one or both sides of the slot 118 for improved grip under load could be used. In another embodiment, the slot 118 is substantially rectangular with a part of the slot 118 being a wider rectangle. For example, the center of the slot 118 may be a wider rectangle than the ends of the slot 118. During assembly such an embodiment may enable easier manufacture of the bag closure device 100 by allowing passage through to the other side of the guide member 104 elements of the securing fin 110 which might be wider than the rest of slot 118. For example, such an embodiment could prove beneficial because it may enable a securing fin 110, such as a securing fin 110 with a T profile, to be manufactured and/or assembled with greater ease.

In yet another embodiment, the slot 118 is substantially rectangular and opens up into a larger space which is defined by the entry end 114 of the guide member 104. For example, referring to FIGS. 1 and 3, the slot 118 may open up into an inverted tear drop shaped space. In another embodiment, the slot 118 opens up into a substantially circular shaped space, oval shaped space, or any other shaped space.

In an embodiment, the slot 118 of the guide member 104 enables the securing fin 110 to be conveyed therethrough. In such an embodiment, the width of the slot 118 is larger than the width of the securing fin 110. The width of the slot 118 may be of such a size such that the securing fin 110 and a folded bag are capable of being received by the slot 118 of the guide member 104 in a secure fashion. Such a width of the slot 118 enables a bag to be securely closed and helps to prevent the food in the bag from being exposed to air and becoming stale.

The entry end 114 of the guide member 104 is located furthest away from the point where the receiving member 102 is coupled to the guiding member 104. In a preferred embodiment, as can be seen in FIGS. 2, 4, and 5, the entry end 114 of the guide member 104 is gradually elevated and defines a space. As discussed above, the entry end 114 may define a generally tear drop shaped space, circular shaped space, oval shaped space, or any other shaped space. As is illustrated in FIGS. 1-5, the space defined by the entry end 114 as well as the gradual elevation of the entry end 114 may enable the distal end 108 of the receiving member 102 to protrude therethrough. This in turn enables a folded bag to be received through the entry end 114 of the guide member 104 by the receiving member 102.

In such an embodiment, because the distal end 108 of the receiving member 102 protrudes through the entry end 114 of the guide member 104, the movement of the receiving member 102 is restricted. For example, while the distal end 108 of the receiving member 102 is capable of movement, the movement of the distal end 108 in one direction, such as up, may be restricted by the entry end 114 of the guide member 104 and the movement of the distal end 108 in the other direction, such as down, may be restricted by the main body of the guide member 104. Restricting the motion of the receiving member 102 minimizes the amount of space that can be created when the receiving member 102 receives a bag and thereby minimizes the amount of air that can reach the food in the bag. The restricted motion also may simplify the effort needed to insert a bag as it reduces the need for a hand specifically maintaining alignment of the receiving member 102 with respect to the guide member 104.

In an alternate embodiment, the entry end 114 of the guide member 104 does not define a space. For example, in such an alternate embodiment, the entry end 114 may comprise two pieces on either side of the slot 118 which do not connect to one another. While the distal end 108 of the receiving member 102 in such an embodiment may be situated between the two pieces of the entry end 114, the distal end 108 may not protrude through the entry end 114. Also, in such an alternate embodiment, the movement of the receiving member 102 in one direction, such as up, is not restricted by the entry end 114.

As discussed above, the movement of the distal end 108 of the receiving member 102 enables a bag to be received by the receiving member 102 with greater ease. For example, the distal end 108 of the receiving member 102 may be pushed upward while receiving a bag through the entry end 114 of the guide member 104 in order to create more space for the bag to be received by the receiving member 102. Once the receiving member 102 receives a load, such as a bag, the weight of the bag forces the receiving member 102 against the guide member 104. Because the bag is situated between the receiving member 102 and the guide member 104, when a load is applied, the bag is securely fitted between the receiving member 102 and the guide member 104. Such a secure fitting of the bag helps to reduce or prevent outside air from entering the bag and inside air from escaping the bag.

Referring now to FIG. 6, the bag closure device 100 may also comprise a handle 122. The handle 122 may be coupled to the top or bottom of the guide member 104. In an embodiment, the handle 122 is located substantially in the center of the guide member 104. The handle 122 may be made of the same material as the receiving member 102 and/or the guide member 104. In an embodiment, the handle 122 is made of plastic. In an alternate embodiment, the handle 122 is made of another material. The handle 122 enables a user of the bag closure device 100 to transport a bag more easily.

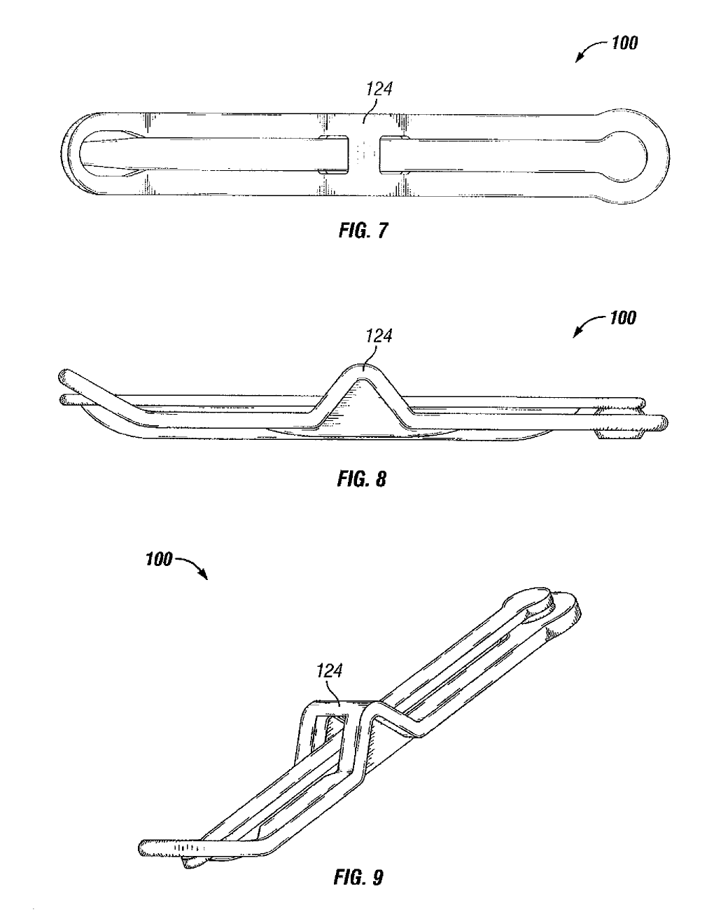

Turning now to FIGS. 7-9, the bag closure device 100 also may comprise a truss 124. The truss 124 is coupled to the front of the guide member 104. In an embodiment, the truss 124 is located substantially in the center of the guide member 104. As a bag is received by the receiving member 102, the bag may be conveyed through the truss 124. Thus, the truss 124 must be of a size such that a bag can be conveyed therethrough.

The truss 124 may provide structural support for the guide member 104. For example, the truss 124 may help to reduce, and in some cases prevent, undesired bending of the guide member 104 under load. As the length of guide member 104 is increased, the guide member 104 has a tendency to bow out towards the center of the guide member 104. The truss 124 can help to support the guide member 104 and prevent the guide member 104 from bowing at the center of the guide member 104.

Additionally, the truss 124 may help to ensure that the effectiveness of the bag closure device 100 is maintained. For example, depending on the angle at which the closure device is held and particularly if the closure device is dropped, there may be a potential for movement or bending of the receiving member 102 away from the guide member 104 which can reduce the fluid restriction performance of the bag closure device 100. The truss 124 restricts the movement of the receiving member 102, which in turn restricts the movement of the bag on the receiving member 102. This restriction of movement of the receiving member 102 with respect to the guide member 104 created by the truss 124 helps enhance the performance of the bag closure device 100 under load throughout the length of the bag.

In an embodiment, the truss 124 is made of the same material as the receiving member 102 and/or the guide member 104. The truss 124 may be made of plastic or another material. In one embodiment, the truss 124 is simultaneously formed in one molding with the guide member 104.

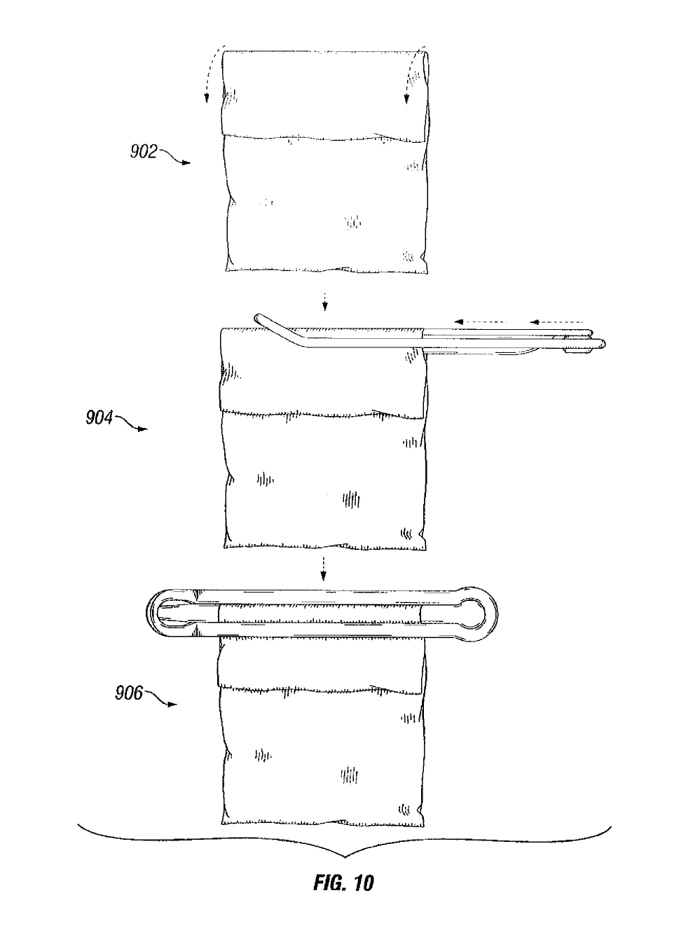

Now referring to FIG. 10, an explanatory drawing is provided to illustrate how to use the bag closure device 100. Step 902 illustrates the starting process of using the bag closure device 100. As illustrated in step 902, the bag is folded over. Sometimes bags, such as dog food bags, comprise a number of sheets. Folding a bag as illustrated in step 902 relieves the user from having to hassle with the individual sheets. The receiving member 102 receives the folded bag as is illustrated in step 904.

Step 904 illustrates inserting the folded bag onto the distal end 108 of the receiving member 102 through the entry end 114 of the guide member 104 and sliding the bag closure device 100 such the receiving member 102 receives the folded bag. Alternatively, the bag closure device 100 may remain stationary while the folded bag is slid along the receiving member 102. As discussed above, the distal end 108 of the receiving member 102 may be moved upward to enable the folded bag to be received through the entry end 114 of the guide member 104 by the distal end 108 of the receiving member 102 more easily. As is illustrated in step 904, both ends of the folded bag are conveyed through the slot 118.

Step 906 illustrates the end result of using the bag closure device 100. As discussed above, as the bag closure device 100 is moved along the folded bag or as the bag is moved along the receiving member 102, such as when the bag is in the position on the bag closure device 100 illustrated in step 906, the weight of the bag forces the receiving member 102 against the guide member 104. This in turn sandwiches the bag around the receiving member 102 against the guide member 104. For example, the bag may be securely fitted between the bottom of the receiving member 102 and the top of the guide member 104.

Additionally, the folded bag may be sandwiched between the securing fin 110 of the receiving member 102 and the slot 118 of the guide member 104. For example, one end of the folded bag is sandwiched between one side of the securing fin 110 and one side of the slot 118 and the other side of the folded bag is sandwiched between the other side of the securing fin 110 and the other side of the slot 118. As discussed above, the slot 118 can be of a size such that the folded bag and the securing fin 110 securely fit therethrough. The secure fitting of a bag between the receiving member 102 and the guide member 104 (e.g., between the bottom of the receiving member 102 and the top of the guide member 104 and/or between the securing fin 110 of the receiving member 102 and the slot 118 of the guide member 104) helps to prevent outside air from reaching the food in the bag and causing the food to go stale.

In an embodiment, once the bag is completely on the receiving member 102, an improved secure fitting of the bag within the bag closure device 100 is achieved by rotating the bag closure device 100 ninety degrees or less from its horizontal position. For example, as is illustrated in step 906, a user can ensure that the bag is securely fit within the bag closure device 100 by rotating the bag closure device 100 ninety degrees from its horizontal position.

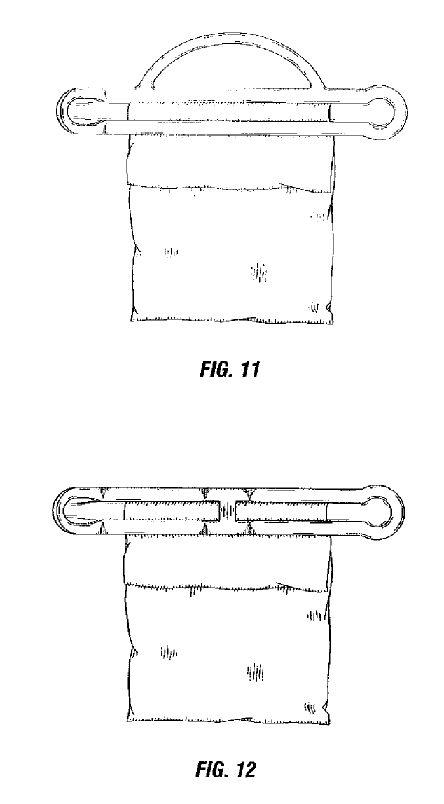

In an embodiment, if the bag closure device 100 comprises the handle 122, the end result of using the bag closure device 100 is illustrated in FIG. 11. As discussed above, the handle 122 enables a user to move the bag easier.

In another embodiment, if the bag closure device 100 comprises the truss 124, the end result of using the bag closure device 100 is illustrated in FIG. 12. As discussed above, the truss 124 provides structural support for the guide member 104 and ensures that effectiveness of the bag closure device 100 is maintained along the entire length of the bag.

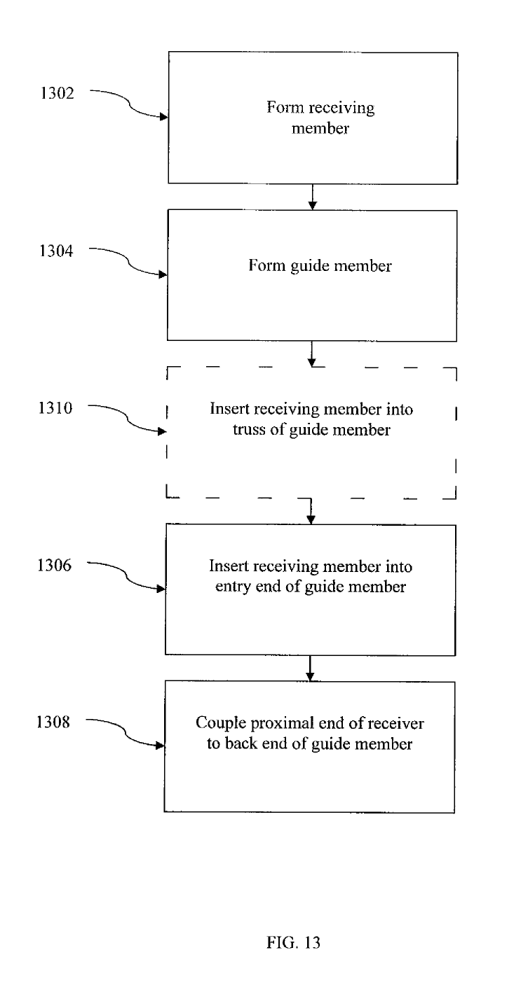

FIG. 13 is a flow chart illustrating a method of manufacturing the bag closure device 100. The method begins at step 1302 where a receiving member 102 is formed. As disclosed above, the receiving member 102 may comprise a distal end 108, a proximal end 106, a securing fin 110, and a male connector 120. At step 1304 a guide member 104 is formed. As mentioned above, the guide member 104 may comprise an entry end 114, a back end 112, a slot 118, and a female connector 116. In an alternate embodiment, the guide member 104 also comprises a handle 122 and/or a truss 124. Step 1304 could occur before step 1302 (i.e., the guide member 104 could be formed before the receiving member 102 is formed) or steps 1302 and 1304 could occur simultaneously (i.e., the guide member 104 and the receiving member 102 are formed at the same time).

The method progresses to step 1306 where the receiving member 102 is inserted through the entry end 114 of the guide member 104. In an embodiment, the entry end 114 of the guide member 104 is elevated gradually and defines a space. In such an embodiment, the receiving member 102 has to be inserted into entry end 114 prior to coupling the proximal end 106 of the receiving member 102 to the back end 112 of the guide member 104. In an embodiment, the proximal end 106 of the receiving member 102 is of a size and/or shape such that the proximal end 106 cannot be conveyed through the entry end 114 of the guide member 104. In such an embodiment, because the proximal end 106 of the receiving member 102 cannot fit through the entry end 114 of the guide member 104, the distal end 108 of the receiving member 102 is inserted into the entry end 114 of the guide member 104.

Next, at step 1308 the proximal end 106 of the receiving member 102 is coupled to the back end 112 of the guide member 104. For example, the male connector 120 of the receiving member 102 may be inserted into the female connector 116 of the guide member 104. As discussed in the preceding paragraph, the shape of the entry end 114 of the guide member 104 may require that step 1308 occur after the inserting of the distal end 108 of the receiving member 102 through the entry end 114 of the guide member 104 (i.e., step 1306). The securing fin 110 of the receiving member 102 may be fitted into the slot 118 of the guide member 104 while or before coupling the receiving member 102 to the guide member 104.

Step 1310 is optional as is illustrated by the dashed lines. If the guide member 104 comprises a truss 124, step 1310 occurs. At step 1310, the receiving member 102 is inserted through the truss 124 prior to the coupling of the receiving member 102 to the guide member 104 (i.e., step 1308). While step 1310 is illustrated as occurring prior to step 1306, step 1310 could also occur after to step 1306. For example, in an alternate embodiment, the proximal end 106 of the receiving member 102 may be of a small enough size and/or shape that it can be conveyed through the entry end 114 of the guide member 104 and the truss 124. In such an alternate embodiment, the proximal end 106 of the receiving member 102 may be inserted into the entry end 114 of the guide member 104 (i.e., step 1306) first and then the proximal end 106 of the receiving member 102 may be inserted into the truss 124 (i.e., step 1308).

As discussed above, the proximal end 106 of the receiving member 102 may be of a size and/or shape such that the proximal end 106 cannot be conveyed through the truss 124 of the guide member 104. In such an embodiment, because the proximal end 106 of the receiving member 102 cannot fit through the truss 124 of the guide member 104, the distal end 108 of the receiving member 102 is inserted into the truss 124 of the guide member 104. Also, in such an embodiment, step 1310 must occur prior to step 1306.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A bag closure device, comprising:
a receiving member that comprises a securing fin; and
a guide member, wherein one end of the receiving member is coupled to one end of the guide member.

2. The bag closure device of claim 1, wherein the receiving member comprises a T-shaped cross-sectional shape.

3. The bag closure device of claim 1, wherein when a load is applied the receiving member is forced against the guide member.

4. The bag closure device according to claim 1, wherein the other end of the receiving member that is not coupled to the one end of the guide member is gradually narrowed.

5. The bag closure device of claim 1, wherein the one end of the guide member coupled to the one end of the receiving member is generally round.

6. The bag closure device of claim 1, wherein the securing fin is substantially perpendicular to the receiving member.

7. The bag closure device of claim 6, wherein the securing fin of the receiving member is received by a slot of the guide member.

8. A bag closure device, comprising:
a receiving member that comprises a distal end, a proximal end, and securing fin, wherein the receiving member has a T-shaped cross-sectional shape; and
a guide member that comprises an entry end, a back end, and a slot, wherein the entry end is gradually elevated and defines a space, wherein the proximal end of the receiving member is coupled to the back end of the guide member, and wherein the slot of the guide member receives the securing fin of the receiving member.

9. The bag closure device of claim 8, wherein the receiving member extends beyond the slot of the guide member.

10. The bag closure device of claim 8, wherein the distal end of the receiving member protrudes through the entry end of the guide member.

11. The bag closure device of claim 8, wherein the receiving member is configured to receive a bag at the distal end of the receiving member through the entry end of the guide member.

12. The bag closure device of claim 8, wherein the receiving member is movable, and wherein the motion of the receiving member is restricted by the guide member and the entry end of the guide member.

13. The bag closure device of claim 8, wherein the receiving member further comprises a first half of a mating connector coupled to the proximal end of the receiving member and the guide member further comprises a second half of a mating connector coupled to the back end of the guide member, and wherein the proximal end of the receiving member is coupled to the back end of the guide member when the first half of the mating connector and the second half of the mating connector connect to one another.

14. The bag closure device of claim 8, wherein the guide member further comprises a handle, and wherein the handle is substantially in the middle of the guide member.

15. The bag closure device of claim 8, wherein the guide member further comprises a truss and wherein the truss is substantially in the middle of the guide member.

16. A method for manufacturing a bag closure device, comprising:
forming a receiving member comprising a distal end, a proximal end, and a securing fin;
forming a guide member comprising an entry end, a back end, and a slot;
inserting the receiving member through the entry end of the guide member; and
coupling the proximal end of the receiving member to the back end of the guide member after the inserting of the receiving member through the entry end.

17. The method of claim 16, wherein forming the guide member comprises forming the entry end of the guide member such that the entry end is gradually elevated and defines a space.

18. The method of claim 16, wherein the securing fin is inserted into the slot prior to or during the coupling of the proximal end of the receiving member to the back end of the guide member.

19. The method of claim 16, wherein forming the guide member further comprises forming a truss, and wherein the truss is located substantially in the center of the guide member.

20. The method of claim 19, further comprising inserting the receiving member through the truss of the guide member prior to the coupling of the proximal end of the receiving member to the back end of the guide member.
